(19) United States
(12) Patent Application Publication
(10) Pub. No.: US 2023/0406280 A1
(43) Pub. Date: Dec. 21, 2023

(54) FRAME WITH A BRAKE ASSEMBLY FOR AN ELECTRIC VEHICLE

(71) Applicant: E-TRACTION EUROPE B.V., Apeldoorn (NL)

(72) Inventor: Wilhelmus Petrus ENGELS, Gemert (NL)

(21) Appl. No.: 18/251,632

(22) PCT Filed: Nov. 4, 2021
(86) PCT No.: PCT/NL2021/050677

§ 371 Date: May 3, 2023

(30) Foreign Application Priority Data
Nov. 6, 2020 (NL) 2026841

(51) Int. Cl. B60T 17/08; B60K 7/00; B60T 13/26

(52) U.S. Cl. CPC B60T 17/088; B60K 7/0007; B60T 13/26; B60Y 2200/143

(57) ABSTRACT

The invention relates to an assembly (1) of a frame member (2) for an electric vehicle comprising a transverse member (14) with at each end a housing (10,10′) connected to the transverse member (14) and two in-wheel motors (3,3′) connected to a respective housing. Each motor comprises a brake drum (35) connected to a rotor (24), extending coaxially within the housing (10,10′) near an inner surface a circumferential wall (8) of the housing. A brake shoe assembly (51,52,55,56) is movable in a radial direction R against the brake drum (35), and an actuator (18,18) is placed on an outer surface (17,17′) of the circumferential wall (8,8′) of the housing (10,10′), connected to the brake shoe assembly (51,52,55,56). The assembly provides a low-floor portal frame member, with two in-wheel motors and a brake system that has relatively small axial dimensions and provides a reduced space envelope at the vehicle side.

### FIELD OF THE INVENTION

The invention relates to an assembly of a frame member for an electric vehicle comprising a transverse member with at each end a housing connected to the transverse member and two in-wheel motors connected to a respective housing, each housing having a side wall and an axially oriented circumferential wall. The invention also relates to an electric vehicle, in particular a bus, comprising such a frame member.

### BACKGROUND OF THE INVENTION

A frame member produced under the tradename AxTrax by the company ZF is known, forming a low-floor portal and carrying two electric motors. Each motor is situated within a twin-tyre rim and is connected to a disc brake system. After removal of the twin tyre rim assembly, the disc brake and brake caliper are accessible from the road side of the chassis.

An in-wheel motor comprising a stator and a rotor that supports the rim, coaxially around the stator, is known from WO2019/017788 in the name of the applicant. The known in-wheel motor has a disc brake assembly at the vehicle side. A frame member extends around the brake caliper and boosters. The known disc brake systems take up a relatively large space in the axial and radial directions on the vehicle side. At the road side, the axial dimensions of the in-wheel motor are laid out for accommodating an as long as possible axially oriented gap between the stator and the rotor of the in-wheel motor for passing a maximum magnetic flux.

It is an object of the present invention to provide a frame member, in particular a low-floor portal frame member, with two in-wheel motors and a brake system that has relatively small axial dimensions and provides a reduced space envelope at the vehicle side, in particular enabling a wide and low floor middle path section in case of a low floor city bus, and at the same time provide a good ground clearance.

It is another object of the present invention to provide a frame member in which the brake system is shielded from the ingress of moisture or dust and dirt, and has parts that can be relatively easily accessed for maintenance and repair.

### SUMMARY OF THE INVENTION

Hereto an assembly according to the present comprises for each in wheel motor:
a non-rotating axle part connected to the side wall of a respective housing, the circumferential wall enclosing a toroidal space around the axle part,
a bearing on the axle part supporting a rotor of the in-wheel motor,
a brake drum connected to the rotor, extending coaxially within the housing near an inner surface the circumferential wall,
a brake shoe assembly connected to the axle part to be movable in a radial direction against the brake drum, and
an actuator placed on an outer surface of the circumferential wall of the housing, connected to the brake shoe assembly.

The brake drum and brake shoes are engaged by movement of the brake shoes in the radial direction only. This results in a reduced axial dimensions. The actuator that is situated on the outer housing surface, at an axial position that substantially correspond to the axial position of the brake shoes, results in a reduced space envelope and allows optimal utilization of the space between the housing side walls, for instance for forming a low floor portal of the vehicle.

The drum brakes according to the invention are less sensitive to the ingress of dirt and water. The brakes will, due to regenerative braking of the electric motor, be utilized less frequently, and have a reduced tendency to stick compared to the known disc brake system.

It is noted that an in-wheel motor having a drum brake on the road side, is known from WO2013/025096, in the name of the applicant. The known drum brake increases the axial dimensions of the in-wheel motor and reduces, at a given track width, the axial space that is available for the magnetic flux gap of the in-wheel motor. Hence for wider vehicles, such as buses or trucks with twin-tyre wheels, this solution is less suitable.

In an embodiment according to the invention, the actuator comprises a push rod that is connected to a lever system that is attached to the housing in a hinge point. The lever system engages with a cam axle that extends through the side wall of the housing in an axial direction for rotation of the brake cam. The brake cam engages with the brake shoes for radial displacement of the brake shoes.

The actuator and lever assembly have a relatively small space envelope and can be easily accessed. As the actuator is placed on the outer surface of the housing, its dimensions may be larger while maintaining a large free area between the opposed housings of the opposed in-wheel motors, so that a pneumatic actuator can be used for the exertion of the large braking force that is required on trucks or buses.

In an assembly according to the invention, each wheel comprises a rim extending at a predetermined height above a road surface. The transverse member extends at a vertical height from the road surface that substantially corresponds to the height of the rim, and is attached to a lower part of the side wall of the housing. In this construction, a floor between the housings can be placed close to the road surface, thus providing easy entry of passengers into the electric vehicle.

### BRIEF DESCRIPTION OF THE DRAWINGS

Some embodiments of an assembly of a frame and two in-wheel motors according to the invention, will by way of non-limiting example, be described in detail with reference to the accompanying drawings. In the drawings:

FIG. 1 shows a perspective view of an assembly according to the invention, with a single in-wheel motor mounted on the frame member,

FIG. 2 shows a cross-sectional view of the assembly of FIG. 1,

FIG. 3 shows a perspective view of the brake assembly and brake shoes according to the invention,

FIG. 4 shows a perspective view of the brake assembly of FIG. 3 from a road-side perspective, and

FIG. 5 shows a plan view of the assembly of FIGS. 1 and 2 with two opposed in-wheel motors mounted on the frame member.

### DETAILED DESCRIPTION OF THE INVENTION

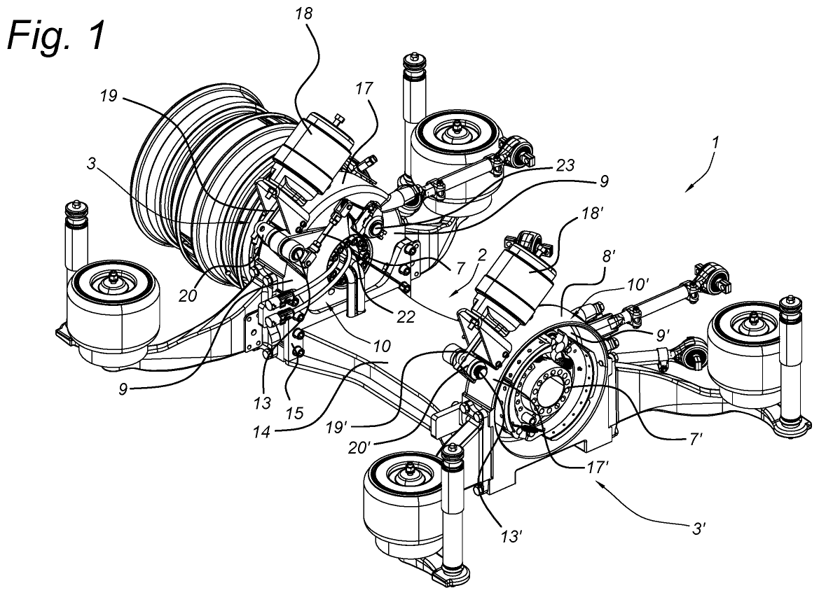

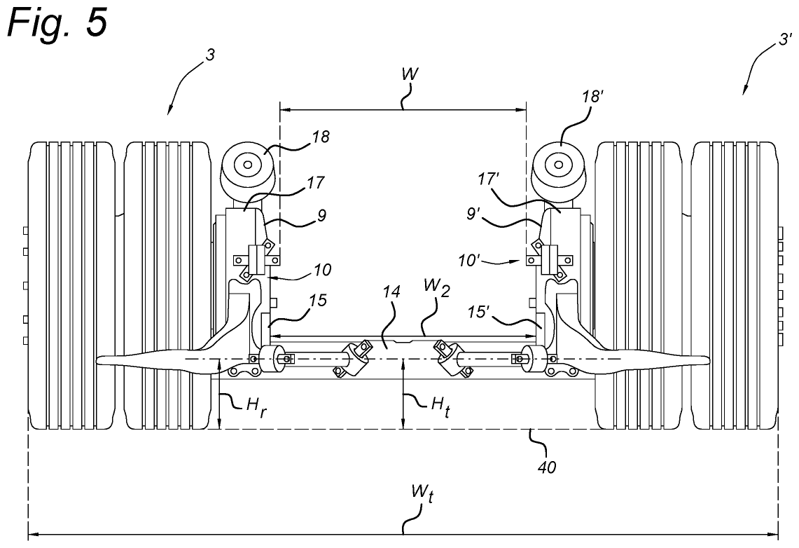

FIG. 1 shows an assembly 1 of a frame member 2, carrying two in-wheel motors 3, 3′. Motor 3′ has been omitted from FIG. 1 for reasons of clarity and is shown in FIG. 5. The details of the in-wheel motors 3,3′ are described in WO2019/017788 in the name of the applicant. The in-wheel motors 3,3 ‘are provided with an axle part 7,7’ that is attached to the side wall 9, 9′ of a housing 10,10′. The housing 10, 10′ is supported by a transverse part 14 of the frame member 2, via flanges 15,15′.

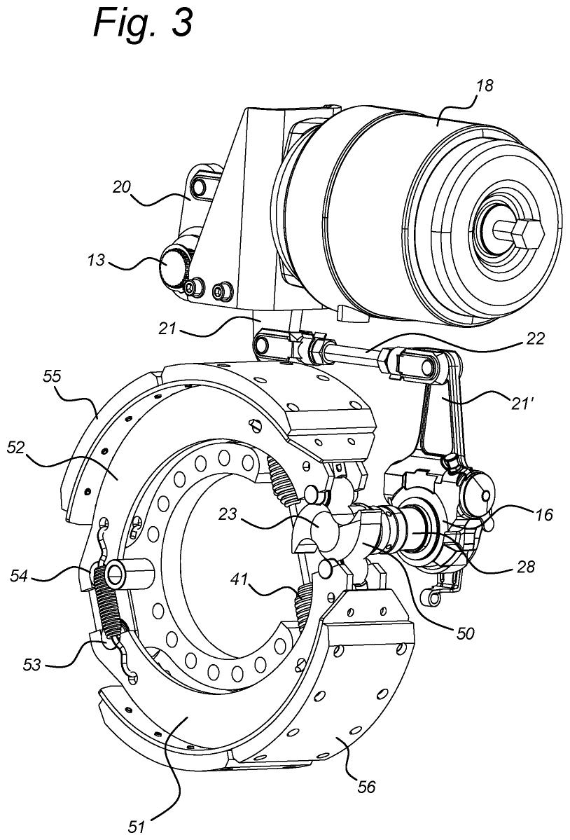

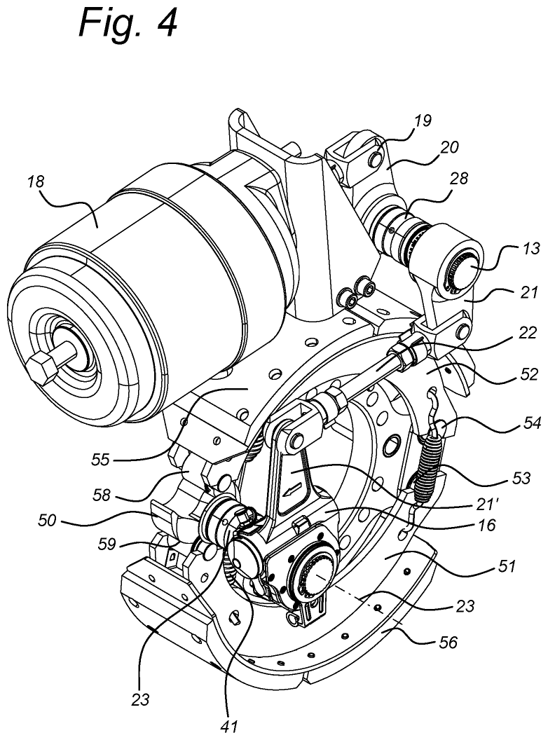

On the outer surface 17, 17′ of the housing 10,10′, pneumatic boosters 18, 18′ are mounted, each connected via a push rod 19,19′ to a hinging lever 20,20′. The levers 20, 20′ are connected to the housing 10, 10′ around an axle/lever 13,13′ and engage via a push rod 22, that is part of a linking mechanism, a drive cam 50. The cam axle 23 extends through the sidewall 9 of the housing 10 into the housing interior and engages with the brake shoe 55, 56 shown in FIGS. 3 and 4.

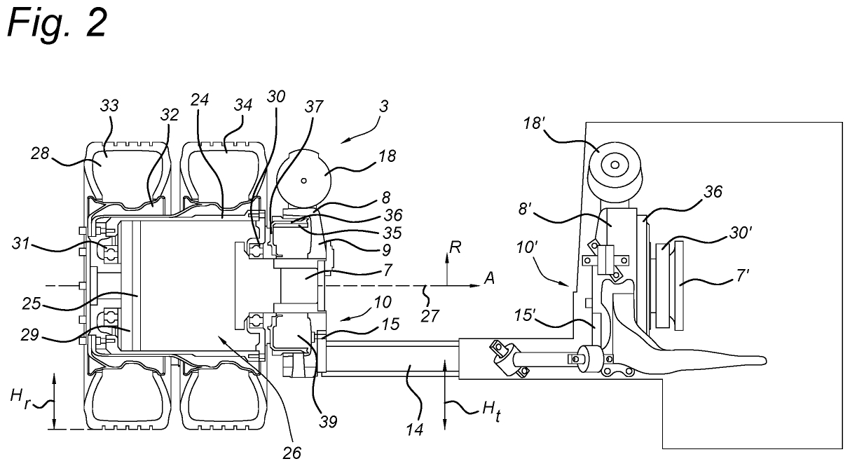

FIG. 2 shows the stator 25 of the in-wheel motor 3, comprising the coil windings and the cooling channels. The stator 25 is at the vehicle side 26 attached to the axle part 7. The rotor 24, comprising permanent magnets, is supported by bearings 30 at the vehicle side 26 and by bearings 31 at the road side 29 of the motor 3 to be rotatable around the axis 27. A pair of coaxially mounted (deep) rims 32 carrying tyres 33, 34 is supported on the rotor 24.

At the vehicle side 26, a brake drum 35 is connected to the rotor 24. The brake drum 35 has a radial brake drum wall 37 and a circumferential brake drum wall 36 that extends coaxially with a circumferential wall 8 of the housing 10. Housing walls 8,9 and the brake drum walls 36,37 enclose a toroidal chamber 39 around the axle part 7, accommodating a brake shoe and an actuator that can be displaced in an axial direction R by rotation of the drive cam 50, shown in FIG. 3.

FIG. 3 shows the brake booster 18 that is connected via the actuator rod, or push rod 19 (see FIG. 4) to bell cranks 21, 21′ which act on a slack adjuster 16 that drives a torque shaft 28. The bell cranks 21, 21′ are interconnected by connecting rod 22, for rotation of the cam axle 23. The cam axle 23 carries at its end a cam 50 that engages with two hinging arms (web) 51,52 that are each mounted in hinge points 53, 54. Rotation of the cam axle 23 results in the cam 50 driving the arms outward by rotation in the hinge points 53, 54. This forces the brake shoes 55,56 radially outward against the inner surface of the break drum wall 36.

FIG. 4 shows the brake assembly from a road side perspective and shows how the S-shaped surface of the cam 50 engages with the cylindrical end parts 58, 59 of the arms 51,52 to force the arms outward on rotation of the cam 50 by the cam axle 23. When the end parts 58,59 engage with a recessed part of the cam 50, the arms 51, 52 are returned back to the center of the brake assembly via springs 41.

As shown in FIG. 5, a free area of a width W along the transverse part 14 of the frame member 2 can be utilized for accommodating passengers or objects. The height Hₜ of the transverse part 14 above a road surface 40 substantially corresponds to the height Hᵣ of the rim 32 from the road surface 40. The low position of the transverse part 14 of the frame member 2 and the large free area W provide an effective low floor portal for transportation of goods and/or persons within a predetermined track width Wₜ. The brake design according to the invention being placed on the vehicle side outside the rotor area, also allows the axial dimensions of the air gap between the rotor 24 and the stator 25 to be as large as possible for generating optimal power in the in-wheel motors 3.3′.

1.-5. (canceled)

6. Assembly of a frame member for an electric vehicle comprising a transverse member with at each end a housing connected to the transverse member and two in-wheel motors connected to a respective housing, each housing having a side wall and an axially oriented circumferential wall, wherein the assembly comprises for each in wheel motor:
a non-rotating axle part connected to the side wall of a respective housing, the circumferential wall enclosing a toroidal chamber around the axle part,
a bearing on the axle part supporting a rotor of the in-wheel motor,
a brake drum connected to the rotor, extending coaxially within the housing near an inner surface the circumferential wall,
a brake shoe assembly connected to the axle part to be movable in a radial direction R against the brake drum, and
an actuator placed on an outer surface of the circumferential wall of the housing, connected to the brake shoe assembly.

7. Assembly according to claim 6, wherein the actuator comprises a push rod that is connected to a lever system that is attached to the housing in a hinge point the lever system engaging with a cam axle extending through the side wall of the housing in an axial direction A for rotation of a cam, the cam engaging with the brake shoe assembly for radial displacement of brake shoes.

8. Assembly according to claim 6, wherein the actuator comprises a pneumatic cylinder.

9. Assembly according to claim 7, wherein the actuator comprises a pneumatic cylinder.

10. Assembly according to claim 6, wherein each wheel comprises a rim extending at a predetermined height above a road surface, the transverse member extending at a vertical height from the road surface that substantially corresponds to the height of the rim, and is attached to a lower part of the side wall of the housing.

11. Assembly according to claim 7, wherein each wheel comprises a rim extending at a predetermined height above a road surface, the transverse member extending at a vertical height from the road surface that substantially corresponds to the height of the rim, and is attached to a lower part of the side wall of the housing.

12. Assembly according to claim 8, wherein each wheel comprises a rim extending at a predetermined height above a road surface, the transverse member extending at a vertical height from the road surface that substantially corresponds to the height of the rim, and is attached to a lower part of the side wall of the housing.

13. Assembly according to claim 9, wherein each wheel comprises a rim extending at a predetermined height above a road surface, the transverse member extending at a vertical height from the road surface that substantially corresponds to the height of the rim, and is attached to a lower part of the side wall of the housing.

14. Electric vehicle, in particular a bus for the transport of people, comprising a frame member with:
a transverse member with at each end a housing connected to the transverse member and two in-wheel motors connected to a respective housing, each housing having a side wall and an axially oriented circumferential wall, wherein the assembly comprises for each in wheel motor:
a non-rotating axle part connected to the side wall of a respective housing, the circumferential wall enclosing a toroidal space around the axle part,
a bearing on the axle part supporting a rotor of the in-wheel motor, a brake drum connected to the rotor, extending coaxially within the housing near an inner surface the circumferential wall,
a brake shoe assembly connected to the axle part to be movable in a radial direction R against the brake drum, and
an actuator placed on an outer surface of the circumferential wall of the housing, connected to the brake shoe assembly, and a bottom support of a passenger space extending between the side walls.
